(19) United States
(12) Patent Application Publication
(10) Pub. No.: US 2011/0313902 A1
(43) Pub. Date: Dec. 22, 2011

(54) Budget Management in a Compute Cloud

(75) Inventors: Su Liu, Round Rock, TX (US); Shunguo Yan, Austin, TX (US)

(73) Assignee: International Business Machines Corporation, Armonk, NY (US)

(21) Appl. No.: 12/818,245

(22) Filed: Jun. 18, 2010

(51) Int. Cl. G06Q 10/00; G06Q 30/00; G06Q 50/00; G06F 15/173

(52) U.S. Cl. 705/34; 709/223

(57) ABSTRACT

A mechanism is provided for managing a budget for a customer in a compute cloud. A cloud budget manager calculates charges for usage of compute cloud resources by each of the customer's services associated with the customer from a beginning of a time period to a current time thereby forming calculated charges. The cloud budget manager estimates charges for a remaining time in the time period thereby forming estimated charges. The cloud budget manager determines whether a sum of the calculated charges and the estimated charges exceeds an allocated budget. The cloud budget manager implements a policy in a plurality of policies that adjusts the level of services of the customer in order to fall within the allocated budget in real time in response to a determination that the sum of the calculated charges and the estimated charges exceeds the allocated budget.

### BACKGROUND

The present application relates generally to an improved data processing apparatus and method and more specifically to mechanisms for managing a budget in a compute cloud.

Cloud computing is Internet-based computing, whereby shared resources, software, and services are provided to computers and other devices on-demand. Cloud computing is a paradigm shift following the shift from mainframe to client—server that preceded cloud computing in the early 1980s. Details are abstracted from the users who no longer have need of expertise in, or control over the technology infrastructure “in the cloud” that supports them. Cloud computing describes a new supplement, consumption and delivery model for information technology (IT) services based on the Internet, and cloud computing typically involves the provision of dynamically scalable and often virtualized resources as a service over the Internet. Cloud computing is a byproduct and consequence of the ease-of-access to remote computing sites provided by the Internet.

The term “cloud” is used as a metaphor for the Internet, based on the cloud drawing used in the past to represent the telephone network, and later to depict the Internet in computer network diagrams as an abstraction of the underlying infrastructure it represents. Typical cloud computing providers deliver common infrastructure and services online which are accessed from another web service or software like a web browser, while the software and data are stored on servers.

However, compute clouds pose a new challenge to an IT department in budget planning. Traditionally, IT budget is more predictable, and is based on expenses on infrastructure (hardware & services) that is owned by the department, as well as the expense on maintenance. When an IT department bases its infrastructure on a compute cloud, the expense is based on usages of compute cloud resources, including hardware, memory, CPU, network (date rate), storage, etc., and software, such as third-party applications, in the compute cloud, as well as other services provided by a compute cloud, such as load balancing, etc., and pay-as-you-go, etc. A compute cloud customer uses compute cloud resources to provide services to their own users. For instance, a compute cloud customer may host their own web applications in a compute cloud, and simultaneously provide a web hosting service to their customers in the same compute cloud. The change in budget planning makes budget predication and management more complicated, particularly when multiple third party applications are used with each having its own pricing model and using different additional resources, such as storage and network. A user knows for sure the charge for such services only after the use, rather than before. An IT department with a particular budget cap for a period may have difficulty determining what services to offer from a compute cloud and for how long for a given budget cap.

### SUMMARY

In one illustrative embodiment, a method, in a data processing system, is provided for managing a budget for a customer in a compute cloud. The illustrative embodiment describes a mechanism for enabling customer budget plan and actions or service profiles responsive to a projected insufficient budget. The illustrative embodiment calculates charges for usage of compute cloud resources by each of the customer's services associated with the customer from a beginning of a time period to a current time thereby forming calculated charges. The illustrative embodiment estimates charges for a remaining time in the time period thereby forming estimated charges. The illustrative embodiment determines whether a sum of the calculated charges and the estimated charges exceeds an allocated budget. Responsive to a determination that the sum of the calculated charges and the estimated charges exceeds the allocated budget, the illustrative embodiment implements a policy in a plurality of policies generated according to customer budget plan and actions or service profiles that adjusts the level of services of the customer in real time in order to fall within the allocated budget.

In other illustrative embodiments, a computer program product comprising a computer useable or readable medium having a computer readable program is provided. The computer readable program, when executed on a computing device, causes the computing device to perform various ones, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 depicts a pictorial representation of an example distributed data processing system in which aspects of the illustrative embodiments may be implemented;

FIG. 2 shows a block diagram of an example data processing system in which aspects of the illustrative embodiments may be implemented;

FIG. 3 depicts a block diagram of the architecture within a compute cloud in accordance with an illustrative embodiment;

FIG. 4 depicts exemplary operations performed by a cloud budget management mechanism to set up one or more policies for a customer in accordance with an illustrative embodiment; and

FIG. 5 depicts exemplary operations performed by a cloud budget management mechanism to implement a policy for a customer in the event of a budget shortage in accordance with an illustrative embodiment.

### DETAILED DESCRIPTION

The illustrative embodiments provide a mechanism for managing a budget in a compute cloud. As stated previously, an IT department with a particular budget cap for a period may have difficulty determining what services to offer from the compute cloud and for how long in order to stay within their budget. Therefore, there may be a benefit for a mechanism that assists in managing a budget by projecting the usages and adjusting a level of services in response to customer's predetermined action on budget shortage. Such a mechanism may provide a flexible and automatic option for small businesses and individuals who have periodic (monthly) IT budget limits while still using a compute cloud to offer services to its own customers.

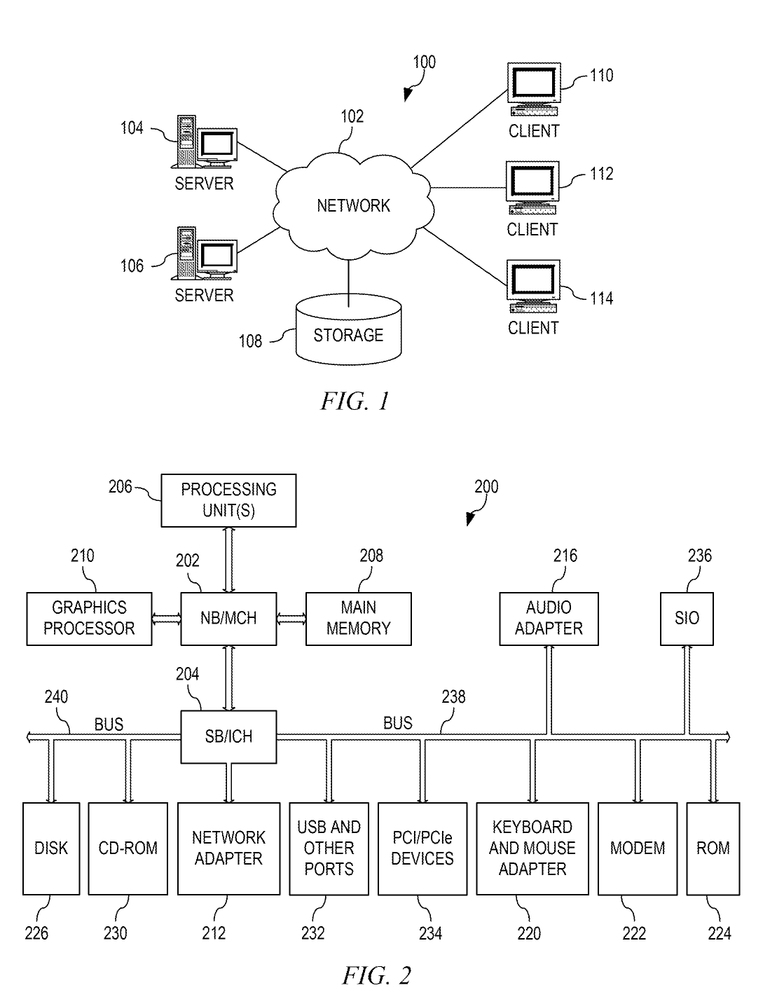

Thus, the illustrative embodiments may be utilized in many different types of data processing environments including a distributed data processing environment, a single data processing device, or the like. In order to provide a context for the description of the specific elements and functionality of the illustrative embodiments, FIGS. 1 and 2 are provided hereafter as example environments in which aspects of the illustrative embodiments may be implemented. While the description following FIGS. 1 and 2 will focus primarily on a single data processing device implementation of a mechanism that manages a budget in a compute cloud, this is only an example and is not intended to state or imply any limitation with regard to the features of the present invention. To the contrary, the illustrative embodiments are intended to include distributed data processing environments and embodiments in which budgets may be managed in a compute cloud.

With reference now to the figures and in particular with reference to FIGS. 1-2, example diagrams of data processing environments are provided in which illustrative embodiments of the present invention may be implemented. It should be appreciated that FIGS. 1-2 are only examples and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of an example distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

With reference now to FIG. 2, a block diagram of an example data processing system is shown in which aspects of the illustrative embodiments may be implemented. Data processing system 200 is an example of a computer, such as client 110 in FIG. 1, in which computer usable code or instructions implementing the processes for illustrative embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on data processing system 200 (Java is a trademark of Sun Microsystems, Inc. in the United States, other countries, or both).

As a server, data processing system 200 may be, for example, an IBM® eServer™ System p® computer system, running the Advanced Interactive Executive (AIX®) operating system or the LINUX® operating system (eServer, System p, and AIX are trademarks of International Business Machines Corporation in the United States, other countries, or both while LINUX is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device which is configured with flash memory to provide non-volatile memory for storing operating system files and/or user-generated data, for example. Essentially, data processing system 200 may be any known or later developed data processing system without architectural limitation.

The illustrative embodiments describes a mechanism for managing a budget for a customer in a compute cloud by enabling customer budget plan and automatically adjusting levels of services in real time in response to a projected insufficient budget. The mechanism provides compute cloud configuration options for a customer to set up service profiles or services priorities, as well as actions to take when insufficient budget is projected. Each service profile may specify a different level of services or service combinations that requires different usage of resources, and therefore different expenses. The mechanism also provides for periodically projecting usage and charges from each of the customer's services for the future time period based on various factors such as services on schedule, historical data, current trends, etc. The mechanism adjusts levels of services or switches to a different service profile based on the configuration options.

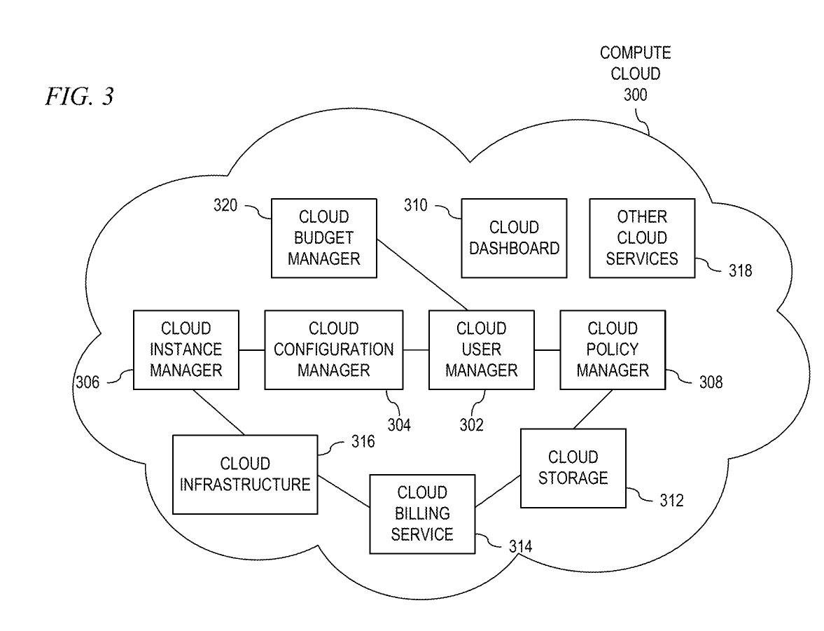

FIG. 3 depicts a block diagram of the architecture within a compute cloud in accordance with an illustrative embodiment. Compute cloud 300 may comprise a cloud user manager 302, cloud configuration manager 304, cloud instance manager 306, and cloud policy manager 308. Cloud user manager 302 manages all of the customers who have requested use of the shared resources, software, and services that is provided by compute cloud 300. The customers of compute cloud 300 may be an individual user or multiple users within a company consolidated into a single customer configuration. Cloud configuration manager 304 manages the configuration for each customer based on the requirements requested by the customer. Cloud instance manager 306 manages the individual instances created for each customer. Cloud policy manager 308 enforces the policies associated with a customer on the use of compute cloud resources, such as user agreements.

Compute cloud 300 may also comprise cloud dashboard 310, cloud storage 312, cloud billing service 314, cloud infrastructure 316. and other cloud services 318. Cloud dashboard 310 may be a graphical user interface for the customer that allows the customer to make configuration changes for usage of compute cloud resources, such as an increase or decrease in number of instances created by cloud instance manager 306 or a increase or decrease in data rate provided by cloud infrastructure 316. Cloud dashboard 310 may also provide an interface to cloud billing service 314 in order to view billing statements or pay bills online. Also, compute cloud 300 may provide other cloud services 318, such as compute cloud monitoring service for monitoring resource usage and performance, load balancing service for dynamically distributing incoming traffic across multiple instances, or the like.

However, the illustrative embodiments are directed to cloud budget manager 320 that provides management of a budget for a customer in compute cloud 300. In order to manage the budget used by customer's services from compute cloud 300, cloud budget manager 320 first has to establish one or more policies for the customer. Cloud budget manager 320 first identifies an allocated budget for a time period specified by the customer. One of ordinary skill in the art will recognize that this step along with many of the following steps may be performed by cloud budget manager 320 through one or more of providing a graphical user interface for the customer to input the information, providing individual prompts for each item of information, parsing a file that may already contain the information, or any other means of identifying the information without departing from the spirit and scope of the invention.

After identifying the allocated budget and the time period, cloud budget manager 320 may further identify whether there is an allowable budget overage indicated. The allowable budget overage may indicate an amount of overage that may be made to the allocated budget in the event adequate changes may not be made within a remaining time of the specified time period in order to fall within the allocated budget. Cloud budget manager 320 then identifies each of the services the customer offers to his users using the resources from the compute cloud 300. With all of the services identified, cloud budget manager 320 identifies a priority that the customer has associated with each of the services. For example, the services a customer may offer may include a web server, an account server, human resource applications, product demo service, knowledge base services, and backup services. For each of the services, cloud budget manager 320 may identify a priority that the customer wants associated with the service, for example, a high or 1 priority associated with the web server and the account server, a medium-high or 2 associated with the human resource applications, a medium or 3 priority with the product demo service, a medium-low or 4 associated with the knowledge base services, and a low or 5 associated with the backup services. While the illustrative embodiments use high, medium-high, medium, medium-low, low and/or 1-5 to associate a priority level with the services, one of ordinary skill in the art may recognize that any indicator and/or number of indicators may be used without departing from the spirit and scope of the invention.

With a priority associated with each service that the customer offers by using the resources from the compute cloud, cloud budget manager 320 then proceeds with identifying one or more actions that is to be implemented for each service if a budget shortage is detected. The customer may identify actions such as for high priority services run (i.e., no action) regardless of budget level (sufficient or short), while lower priority services may be rescheduled, execution-frequency reduced, stopped, or the like, depending on customer's configuration choice. The customer may also indicate actions such as not to shutdown any service, but move a scheduled service to or use certain services at a different time to avoid running at peak time and increase productivity. The customer may also indicate actions such as reducing execution frequencies of a scheduled yet expensive service, decrease capacity and/or scale service applications down based on current usage, or the like. In another example, the customer may also indicate actions such that a service may be shutdown at certain times, such as nights, weekends, holidays, or the like. By changing the level of services, the compute cloud resources used by the services are changed accordingly. The associated budget may thus be managed or controlled.

Cloud budget manager 320 may apply a different service profile for the customer in response to a projected budget shortage. That is, instead of specifying actions to be implemented in the event of a budget shortage for the services, the customer may provide various usage qualities of service profiles and criterion for different profiles to apply in the event of a budget shortage. Profiles may be simply corresponding to the available budget. However, other profiles may indicate what actions to take based on the time remaining in the identified time period. Further, other profiles may indicate a certain time range or certain time of day that the profile may be implemented.

The service actions and profiles may be used by cloud budget manager to generate one or more policies for the service of the customer in response to various level of projected budget shortages. With one or more policies generated for the services of the customer, cloud budget manager 320 uses billing information from cloud billing service 314 to obtain charges incurred from each of the customer's services from the beginning of the time period to the current day and/or time. Based on such information as historical data and current trend, cloud budget manager 320 estimates charges for each of the customer's services for the remaining time in the time period. Cloud budget manager 320 then determines whether the sum of the calculated charges and the estimated charges exceeds the allocated budget. If cloud budget manager 320 determines that a budget shortage is projected, then cloud budget manager 320 generates an alert with detailed up-to-date and estimated usage and charges as well as recommendations for staying within the original budget. Based on a predetermined setting provided by the customer, cloud budget manager 320 may either wait for a predetermined amount of time for the customer to manually indicate or automatically implement and adjust a level of the customer's services. Cloud budget manager 320 may identify which profile to implement based upon at least one of remaining time in the time period, projected budget shortage, time of day, day of the week, day within the time period, or the like. Again, cloud budget manager 320 may automatically identify a profile and implement the profile automatically based on a customer predetermined setting and projected budget usage, or cloud budget manager 320 may wait for the customer to select a profile to implement and then implement the profile. The customer may switch in/out of these profiles manually whether the profile is implemented based on a manual response or if the profile was implemented automatically through the use of a manual override.

If cloud budget manager 320 determines that a currently implemented profile is failing to satisfy the budget plan for the rest of the identified time period, cloud budget manager 320 may implement a different profile that attempts to bring the customer's services within the allocated budget. In the event that cloud budget manager 320 fails to identify any profile that will bring the customer's services within the allocated budget, cloud budget manager 320 may determine whether the addition of an indicated allowable budget overage, if present, allows a profile to be identified that will bring the customer's services within the allocated budget including the allowable budget overage. If cloud budget manager 320 identifies such a policy, then cloud budget manager 320 implements the policy. If cloud budget manager 320 fails to identify such a policy, then cloud budget manager 320 may implement the most restrictive policy.

Additionally, if cloud budget manager 320 fails to identify any profile that that will bring the customer's services within the allocated budget including the allowable budget overage or, if there fails to be an allowable budget overage and cloud budget manager 320 fails to identify any profile that that will bring the customer's services within the allocated budget, cloud budget manager 320 may determine whether there is any profile within the compute cloud, such as in cloud policy manager 308, that may provide actions that will bring the customer's services within the allocated budget with or without the allowable budget overage.

Thus, cloud budget manager 320 implementation of any profile may translate into a projected cost savings sufficient to bring the projected budget back within the allocated budget with or without the allowable budget overage while allowing the customer's services to run at the priority assigned by the customer. Thus, cloud budget manager 320 helps customers optimize the use of compute cloud resources while keeping expenses on cap. A computer cloud, such as compute cloud 300, may gain a competitive advantage by providing such flexible and automatic options as those provided by cloud budget manager 320.

As will be appreciated by one skilled in the art, the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in any one or more computer readable medium(s) having computer usable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, device, or any suitable combination of the foregoing. More specific examples (a non-exhaustive list) of the computer readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in a baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Computer code embodied on a computer readable medium may be transmitted using any appropriate medium, including but not limited to wireless, wireline, optical fiber cable, radio frequency (RF), etc., or any suitable combination thereof.

Computer program code for carrying out operations for aspects of the present invention may be written in any combination of one or more programming languages, including an object oriented programming language such as Java™, Smalltalk™, C++, or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to the illustrative embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions that implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flowchart and/or block diagram block or blocks.

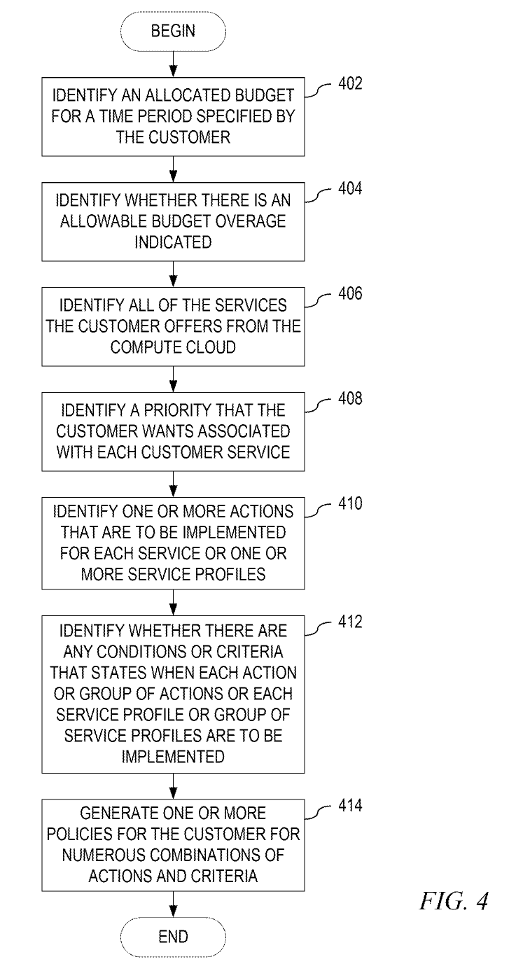

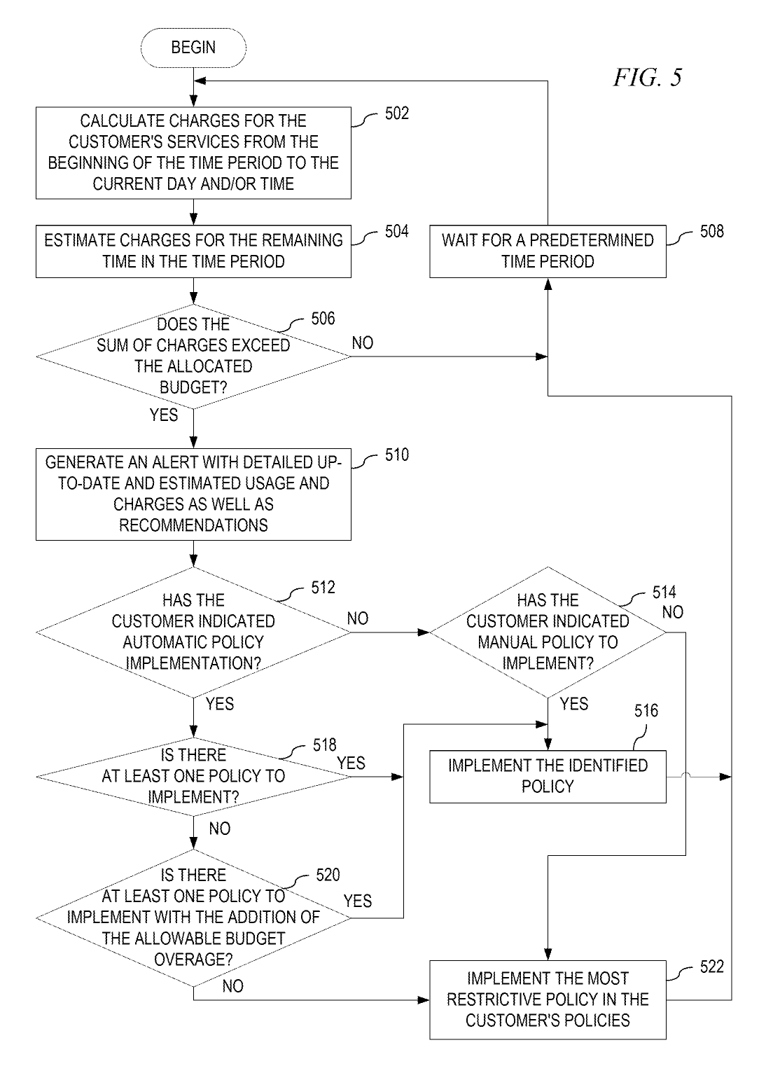

Referring now to FIGS. 4-5, these figures provide flowcharts outlining example operations of a mechanism for managing a budget for a customer in a compute cloud. FIG. 4 depicts exemplary operations performed by a cloud budget management mechanism to set up one or more policies for a customer in accordance with an illustrative embodiment. As the operation begins, a cloud budget manager identifies an allocated budget for a time period specified by the customer (step 402). The cloud budget manager identifies whether there is an allowable budget overage indicated (step 404). The cloud budget manager identifies all of the services the customer offers from the compute cloud (step 406). For each of the customer's services, the cloud budget manager identifies a priority that the customer wants associated with each customer's service (step 408).

With a priority associated with each service that the customer offers from the compute cloud by using the compute cloud resources, the cloud budget manager proceeds with identifying one or more actions that are to be implemented for each service or one or more service profiles if a budget shortage is detected (step 410). The cloud budget manager then identifies whether there are any conditions or criteria that states when each action or group of actions or each service profile or group of service profiles are to be implemented (step 412). Finally, once the cloud budget manager has identified all the information, the cloud budget manager generates one or more policies for the customer (step 414), with the operation ending thereafter. Each policy may be one or more actions associated with a service or one or more profiles for the customer for numerous combinations of actions and criteria, and each policy may be associated with a level of projected budget shortage. The operation described in FIG. 4 may be performed each time that the customer changes an action associated with a customer service, adds or deletes a service, or makes any change with regard to the use of the compute cloud. All previous profiles for the customer may be reloaded at the beginning of the operation described in FIG. 4.

FIG. 5 depicts exemplary operations performed by a cloud budget management mechanism to implement a policy for a customer in the event of a budget shortage in accordance with an illustrative embodiment. As the operation begins, the cloud budget manager communicates with compute cloud billing service to obtain charges for the usage of the resources incurred by each of customer's services from the beginning of the time period to the current day and/or time (step 502). Based on the historical billing or other information (e.g., current trends), the cloud budget manager estimates charges for each of the customer's services for the remaining time in the time period (step 504). The cloud budget manager determines whether the sum of the calculated charges and the estimated charges exceeds the allocated budget (step 506). If at step 506 cloud budget manager determines that there will not be a budget shortage, then the cloud budget manager waits for a predetermined time period (step 508) before returning to step 502.

If at step 506 the cloud budget manager determines that a budget shortage is projected, then the cloud budget manager generates an alert with detailed up-to-date and estimated usage and charges as well as recommendations for staying within the original budget (step 510). The cloud budget manager then determines whether the customer has indicated automatic policy implementation (step 512). If at step 512 the customer fails to indicated automatic policy implementation, then the cloud budget manager waits for the customer to indicate a manual policy to implement (step 514). If at step 514 the customer indicates the manual policy to implement, then the cloud budget manager implements the identified policy (step 516), with the operation proceeding to step 508 thereafter. If at step 514 the customer fails to indicate a selected policy within the amount of wait time, then the cloud budget manager implements the most restrictive policy in the customer's policies (step 522), with the operation proceeding to step 508 thereafter.

If at step 512 the customer indicates an automatic policy implementation, then the cloud budget manager attempts to identify at least one policy to implement based upon at least one of remaining time in the time period, projected budget shortage, time of day, day of the week, or day within the time period, that if implemented will bring the customer's services within the allocated budget (step 518). If at step 518 the cloud budget manager identifies at least one policy, then the operation proceeds to step 516. If at step 518 the cloud budget manager fails to identify at least one policy that will bring the customer's services within the allocated budget, then the cloud budget manager may determine whether the addition of an indicated allowable budget overage, if present, allows a profile to be identified that will bring the customer's services within the allocated budget including the allowable budget overage (step 520). If at step 520 the cloud budget manager identifies such a policy, then the operation proceeds to step 516. If at step 520 the cloud budget manager fails to identify such a policy, then cloud budget manager implements the most restrictive policy in the customer's policies (step 522), with the operation proceeding to step 508 thereafter.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, the illustrative embodiments provide mechanisms managing a budget for a customer in a compute cloud by enabling customer budget plan and automatically adjusting levels of services in real time in response to a projected insufficient budget. The mechanism provides compute cloud configuration options for a customer to set up service profiles and services priorities, as well as actions to take when insufficient budget is projected. The mechanism also provides for periodically projecting usage and charges from the customer's services for the future time period based on various factors such as services scheduled, historical data, current trends, etc. The mechanism adjusts levels of services or switches to a different service profile based on the configuration options.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for managing a budget for a customer in a compute cloud, the method comprising:
calculating, by a cloud budget manager, charges for usage of compute cloud resources by each of the customer's services associated with the customer from a beginning of a time period to a current time thereby forming calculated charges;
estimating, by the cloud budget manager, charges for a remaining time in the time period thereby forming estimated charges;
determining, by the cloud budget manager, whether a sum of the calculated charges and the estimated charges exceeds an allocated budget; and
responsive to a determination that the sum of the calculated charges and the estimated charges exceeds the allocated budget, implementing, by the cloud budget manager, a policy in a plurality of policies that adjusts a level of services of the customer in order to fall within the allocated budget.

2. The method of claim 1, wherein the policy in the plurality of policies is identified through at least one of a manual selection or an automatic selection.

3. The method of claim 2, wherein identifying the policy in the plurality of policies through the manual selection comprises:
generating, by the cloud budget manager, an alert with detailed up-to-date and estimated usage and charges as well as recommendations for staying within the allocated budget;
receiving, by the cloud budget manager, a selection of the policy in the plurality of policies by the customer thereby forming a selected policy; and
implementing, by the cloud budget manager, the selected policy that adjusts the services of the customer in order to fall within the allocated budget.

4. The method of claim 2, wherein identifying the policy in the plurality of policies through the automatic selection comprises:
determining, by the cloud budget manager, whether there is at least one policy in the plurality of policies to implement that, if implemented, will bring the services of the customer within the allocated budget; and
responsive to identifying the at least one policy, implementing, by the cloud budget manager, the at least one policy that adjusts the services of the customer in order to fall within the allocated budget.

5. The method of claim 4, further comprising:
responsive to a failure to identify the at least one policy in the plurality of policies, determining, by the cloud budget manager, whether there is at least one other policy in the plurality of policies to implement that, if implemented, will bring the services of the customer within the allocated budget with an addition of an allowable budget overage; and
responsive to identifying the at least one other policy, implementing, by the cloud budget manager, the at least one other policy that adjusts the services of the customer in order to fall within the allocated budget plus the allowable budget overage.

6. The method of claim 5, further comprising:
responsive to a failure to identify the at least one other policy in the plurality of policies, implementing, by the cloud budget manager, a most restrictive policy in the plurality of policies that adjusts the services of the customer.

7. The method of claim 4, wherein the policy in the plurality of policies is automatically identified based upon at least one of remaining time in the time period, projected budget shortage, time of day, day of the week, or day within the time period.

8. The method of claim 1, further comprising:
generating, by the cloud budget manager, an alert with detailed up-to-date and estimated usage and charges as well as recommendations for staying within the allocated budget.

9. The method of claim 1, wherein each policy in the plurality of policies is generated by the method comprising:
identifying, by the cloud budget manager, the allocated budget for the time period, wherein the time period is specified by the customer;
identifying, by the cloud budget manager, the services offered by the customer by using resources in the compute cloud;
identifying, by the cloud budget manager, a priority associated with each service;
identifying, by the cloud budget manager, one or more actions that are to be implemented for each service if a budget shortage is detected;
identifying, by the cloud budget manager, whether there are any criteria that states when each action or group of actions are to be implemented; and
generating, by the cloud budget manager, one or more profiles for the customer for combinations of the actions and the criteria thereby forming the plurality of policies.

10. A computer program product comprising a computer readable storage medium having a computer readable program stored therein, wherein the computer readable program, when executed on a computing device, causes the computing device to:
calculate charges for usage of compute cloud resources by each of the customer's services associated with the customer from a beginning of a time period to a current time thereby forming calculated charges;
estimate charges for a remaining time in the time period thereby forming estimated charges;
determine whether a sum of the calculated charges and the estimated charges exceeds an allocated budget; and
responsive to a determination that the sum of the calculated charges and the estimated charges exceeds the allocated budget, implement a policy in a plurality of policies that adjusts a level of services of the customer in order to fall within the allocated budget.

11. The computer program product of claim 10, wherein the policy in the plurality of policies is identified through at least one of a manual selection or an automatic selection.

12. The computer program product of claim 11, wherein the computer readable program to identify the policy in the plurality of policies through the manual selection further causes the computing device to:
generate an alert with detailed up-to-date and estimated usage and charges as well as recommendations for staying within the allocated budget;
receive a selection of the policy in the plurality of policies by the customer thereby forming a selected policy; and
implement the selected policy that adjusts the services of the customer in order to fall within the allocated budget.

13. The computer program product of claim 11, wherein the computer readable program to identify the policy in the plurality of policies through the automatic selection further causes the computing device to:
determine whether there is at least one policy in the plurality of policies to implement that, if implemented, will bring the services of the customer within the allocated budget; and
responsive to identifying the at least one policy, implement the at least one policy that adjusts the services of the customer in order to fall within the allocated budget.

14. The computer program product of claim 13, wherein the computer readable program further causes the computing device to:
responsive to a failure to identify the at least one policy in the plurality of policies, determine whether there is at least one other policy in the plurality of policies to implement that, if implemented, will bring the services of the customer within the allocated budget with an addition of an allowable budget overage; and
responsive to identifying the at least one other policy, implement the at least one other policy that adjusts the services of the customer in order to fall within the allocated budget plus the allowable budget overage.

15. The computer program product of claim 14, wherein the computer readable program further causes the computing device to:
responsive to a failure to identify the at least one other policy in the plurality of policies, implement a most restrictive policy in the plurality of policies that adjusts the services of the customer.

16. An apparatus, comprising:
a processor; and
a memory coupled to the processor, wherein the memory comprises instructions which, when executed by the processor, cause the processor to:
calculate charges for usage of compute cloud resources by each of the customer's services associated with the customer from a beginning of a time period to a current time thereby forming calculated charges;
estimate charges for a remaining time in the time period thereby forming estimated charges;
determine whether a sum of the calculated charges and the estimated charges exceeds an allocated budget; and
responsive to a determination that the sum of the calculated charges and the estimated charges exceeds the allocated budget, implement a policy in a plurality of policies that adjusts a level of services of the customer in order to fall within the allocated budget.

17. The apparatus of claim 16, wherein the policy in the plurality of policies is identified through at least one of a manual selection or an automatic selection.

18. The apparatus of claim 17, wherein the instructions to identify the policy in the plurality of policies through the manual selection further cause the processor to:
generate an alert with detailed up-to-date and estimated usage and charges as well as recommendations for staying within the allocated budget;
receive a selection of the policy in the plurality of policies by the customer thereby forming a selected policy; and
implement the selected policy that adjusts the services of the customer in order to fall within the allocated budget.

19. The apparatus of claim 17, wherein the instructions to identify the policy in the plurality of policies through the automatic selection further cause the processor to:
determine whether there is at least one policy in the plurality of policies to implement that, if implemented, will bring the services of the customer within the allocated budget; and
responsive to identifying the at least one policy, implement the at least one policy that adjusts the services of the customer in order to fall within the allocated budget.

20. The apparatus of claim 19, wherein the instructions further cause the processor to:
responsive to a failure to identify the at least one policy in the plurality of policies, determine whether there is at least one other policy in the plurality of policies to implement that, if implemented, will bring the services of the customer within the allocated budget with an addition of an allowable budget overage; and
responsive to identifying the at least one other policy, implement the at least one other policy that adjusts the services of the customer in order to fall within the allocated budget plus the allowable budget overage.

21. The apparatus of claim 20, wherein the instructions further cause the processor to:
responsive to a failure to identify the at least one other policy in the plurality of policies, implement a most restrictive policy in the plurality of policies that adjusts the services of the customer.
